(19) United States
(12) Patent Application Publication
(10) Pub. No.: US 2005/0130039 A1
(43) Pub. Date: Jun. 16, 2005

(54) Electrode plate for nonaqueous electrolyte secondary battery, method of producing the same and nonaqueous electrolyte secondary battery

(76) Inventors: Toshihito Shimizu, Tokyo (JP); Takeshi Ohmae, Tokyo (JP); Hideki Usuki, Tokyo (JP); Yoshiaki Ooyari, Tokyo (JP); Tomoya Sasaki, Tokyo (JP)

Correspondence Address: SEYFARTH SHAW, 55 EAST MONROE STREET, SUITE 4200, CHICAGO, IL, 60603-5803, US

(21) Appl. No.: 10/954,881

(22) Filed: Sep. 30, 2004

(30) Foreign Application Priority Data
Sep. 30, 2003 (JP) 2003-342341
Mar. 29, 2004 (JP) 2004-096480

(51) Int. Cl. H01M 4/62; B26D 1/24

(52) U.S. Cl. 429/217; 83/495

(57) ABSTRACT

An electrode plate for nonaqueous electrolyte secondary batteries comprises a collector and an active material layer which is provided on one side or both sides of the collector, wherein the active material layer has low adhesion strength, low shear strength, and high bending strength, and the electrode plate is produced by a process comprising the steps of: providing a semimanufactured electrode plate which comprises a collector and an active material layer provided on the collector, providing a cutting means which comprises at least a pair of upper and lower blades each having a disc-like shape or a cylindrical shape and each having a cutting edge at a rim of its end face portion at one or both ends of its axial direction, and two shafts, one of which is for the upper blade supporting the one or more upper blades, and the other of which is for the lower blade supporting the one or more lower blades, wherein the upper and lower blades are opposed to each other with a positional relation that the two shafts are parallel to each other, that the cutting edges of the upper and lower blades are overlapped each other, and that there is a clearance of about 20 μm to about 50 μm between the end face portions of the upper and lower blades overlapping each other, and allowing the semimanufactured electrode plate to pass between the upper and lower blades of the cutting means so as to cut it.

### BACKGROUND OF THE INVENTION

1. Field of the Invention

The present invention relates to an electrode plate for use in nonaqueous electrolyte secondary batteries typically including lithium-ion secondary batteries, a method of producing the electrode plate and a nonaqueous electrolyte secondary battery using the electrode plate.

2. Description of the Related Art

Recent years have seen rapid advances in miniaturization and weight reduction of electronic equipment and communication equipment. Thus, there has been a demand for miniaturization and weight reduction of secondary batteries for use as a driving power source in such equipment. For this purpose, in place of conventional alkaline storage batteries, there have been proposed nonaqueous electrolyte secondary batteries, typically lithium-ion secondary batteries, which can have a high energy density and a high voltage.

An electrode plate for use as a positive electrode of the nonaqueous electrolyte secondary battery (a positive electrode plate) is produced by using a complex oxide such as lithium manganate and lithium cobaltate as a positive active material, dispersing or dissolving the positive active material and a binder in an appropriate wetting agent (solvent) to prepare a slurry-like coating composition, and applying the coating composition onto a collector made of metal foil so that a positive active material layer is formed thereon.

On the other hand, an electrode plate for use as a negative electrode of the nonaqueous electrolyte secondary battery (a negative electrode plate) is produced by using a carbonaceous material such as carbon capable of occluding cation such as lithium ion as a negative active material, in which the cation is released from the positive active material at the time of charging, dispersing or dissolving the negative active material and a binder in an appropriate wetting agent (solvent) to prepare a slurry-like coating composition, and applying the coating composition onto a collector made of metal foil so that a negative active material layer is formed thereon.

A terminal for taking out electric current is then attached to each of the positive and negative electrode plates, both of which are then wound up with a separator sandwiched therebetween for preventing short circuit and sealed in a container filled with a nonaqueous electrolyte solution, so that a secondary battery is constructed.

In recent years, there has also been a demand for a nonaqueous electrolyte secondary battery with higher capacity, and various improvements have been made. An example of such improvements is a method of increasing the density of the active material layer, which includes the step of pressing the electrode twice or more so as to increase the amount of the electrode active material per unit volume. Another example of such improvements is a method of reducing as much as possible the materials having no direct effect on the battery capacity, such as a binder for fixing the active material onto the collector and an electrically conductive material for ensuring electrical conductivity.

When the amount of the electrode active material per unit volume is increased by the step of pressing the electrode twice or more so that the density of the active material layer is increased, the active material layer tends to be hard and thus to have a high bending strength. When the content of the binder in the active material layer is reduced for the purpose of producing a high capacity battery, the adhesion strength of the coating film to the collector can be reduced, and the active material layer tends to be brittle and thus to have a low shear strength. Such an electrode plate, with low adhesion strength of the coating film to the collector, low shear strength of the active material layer and high bending strength, can cause a problem such as dropping of the active material layer, when the electrode plate is cut into pieces with a specific width or when the electrode plate is wound together with the counter electrode and a separator.

For example, the cutting may be performed using a gang-blade type cutter with blades pressed against each other, using such as a gang-blade type cutter 11 as shown in FIG. 1 with gang blades having a certain tilt amount. In such a case, upper blade 12 and lower blade 13 of the gang blades are each in the shape of a cylinder and each have a circular cutting edge capable of endlessly rotating at an end of each axis direction. The upper blade 12 and the lower blade 13 are provided in such a position that they are able to overlap each other at those edges. The electrode plate (not shown) is allowed to pass between the upper blade 12 and the lower blade 13 and cut with the blades. For example, the tilt amount 14 is set at 50 μm, and the spaces 15a, 15b, 15c, 15a′, 15b′, and 15c′ between the blades are set at 40.88 mm, 41.08 mm, 40.88 mm, 40.98 mm, 40.98 mm, and 40.98 mm, respectively. In this case, the electrode plates produced by cutting through spaces A, B and C, respectively, are as shown in the sectional view of FIG. 2, in which edge portions of the active material layer drop off from the electrode plate produced by cutting through space B, and distortion also occurs as illustrated. Such dropping and distortion can significantly occur when the active material layer is provided on both sides of the collector.

Upon occurrence of the dropping, after a battery is constructed, the dropping fragment of the active material layer can press an isolating substance such as a separator in the battery. Thus, rapid self-discharge problems (soft short, OCV (Open Circuit Voltage) failure) can occur even when the battery is not connected to any device, and problems of a reduction in battery capacity can also occur by the dropping of the active material layer.

Japanese Patent No. 3085101 discloses a machine for cutting an electrode sheet for nonaqueous electrolyte batteries, the object of which is to prevent a metal portion of the electrode sheet from having burrs or beard-like pieces and to reduce the waviness of the cut surface of the electrode sheet. However, such a machine is not able to prevent the active material layer from dropping off, when the active material layer of the electrode plate has low adhesion strength to the collector, low shear strength and high bending strength of the active material layer.

### SUMMURY OF THE INVENTION

The present invention has been made in view of the above circumstances. It is therefore a first object of the present invention to provide a nonaqueous-electrolyte secondary-battery electrode plate which has high capacity and high quality and is produced without dropping of the active material layer in a cutting process, even when the active material layer has low adhesion strength, low shear strength, and high bending strength.

It is a second object of the present invention to provide a method of producing an electrode plate for nonaqueous electrolyte secondary batteries which can produce a high-capacity and high-quality electrode plate for nonaqueous electrolyte secondary batteries with no dropping of the active material layer in a cutting process even when the active material layer has low adhesion strength, low shear strength, and high bending strength.

It is a third object of the present invention to provide a high-capacity and high-quality nonaqueous electrolyte secondary battery which is constructed with the above electrode plate and reduced in self-discharge (soft short, OCV failure).

The present invention is directed to an electrode plate for a nonaqueous electrolyte secondary battery, comprising a collector and an active material layer which is provided on one side or both sides of the collector and contains at least an active material and a binder, wherein the active material layer has an adhesion strength of about 13.5 N/m or less to the collector when provided on both sides of the collector or an adhesion strength of about 6.0 N/m or less to the collector when provided on one side of the collector in terms of JIS-K6854, a shear strength of about 0.10 N/mm² or less in terms of JIS-K7214-1985, and a bending strength of about 15.0 N/mm² or more in terms of JIS-K7171-1994, and the electrode plate is produced by a process comprising the steps of:
providing a semimanufactured electrode plate which comprises a collector and an active material layer provided on the collector, wherein the active material layer has the above adhesion strength, shear strength and bending strength,
providing a cutting means which comprises at least a pair of upper and lower blades each having a disc-like shape or a cylindrical shape and each having a cutting edge at a rim of its end face portion at one or both ends of its axial direction, and two shafts, one of which is for the upper blade supporting the one or more upper blades, and the other of which is for the lower blade supporting the one or more lower blades, wherein the upper and lower blades are opposed to each other with a positional relation that the two shafts are parallel to each other, that the cutting edges of the upper and lower blades are overlapped each other, and that there is a clearance of about 20 μm to about 50 μm between the end face portions of the upper and lower blades overlapping each other, and
allowing the semimanufactured electrode plate to pass between the upper and lower blades of the cutting means so as to cut it.

The electrode plate for a nonaqueous electrolyte secondary battery of the present invention is produced by cutting with the above-stated cutting means having an optimized clearance of about 20 μm to about 50 μm between the end face portions of the upper and lower blades overlapping each other. Thus, the active material layer of such an electrode plate is free from dropping of the end face portion in the cutting process, even when the active material layer has low adhesion strength to the collector, low cohesive strength and low shear strength, because of a high content of the active material and a low content of the binder in the active material layer for high capacity purposes and even when the active material layer is compressed under high pressure to have high density and thus high bending strength. In particular, the end face portion of the active material layer is prevented from dropping off, even when the active material layers are provided on both sides of the collector, which would otherwise cause significant dropping or distortion. Thus, the electrode plate for a nonaqueous electrolyte secondary battery of the present invention can have a low rejection rate and can achieve high capacity and high quality.

In another aspect, the present invention is directed to a method of producing an electrode plate for a nonaqueous electrolyte secondary battery, comprising the steps of:
providing a semimanufactured electrode plate which comprises a collector and an active material layer provided on the collector,
providing a cutting means which comprises at least a pair of upper and lower blades each having a disc-like shape or a cylindrical shape and each having a cutting edge at a rim of its end face portion at one or both ends of its axial direction, and two shafts, one of which is for the upper blade supporting the one or more upper blades, and the other of which is for the lower blade supporting the one or more lower blades, wherein the upper and lower blades are opposed to each other with a positional relation that the two shafts are parallel to each other, that the cutting edges of the upper and lower blades are overlapped each other, and that there is a clearance of about 20 μm to about 50 μm between the end face portions of the upper and lower blades overlapping each other, and
allowing the semimanufactured electrode plate to pass between the upper and lower blades of the cutting means so as to cut it.

The method of producing the electrode plate of the present invention includes the step of performing cutting with a cutting means having an optimized clearance of about 20 μm to about 50 μm between the end face portions of the upper and lower blades overlapping each other. Thus, such a method can produce an electrode plate whose active material layer is free from dropping of the end face portion in the cutting process.

In a further aspect, the present invention is directed to a nonaqueous electrolyte secondary battery, comprising the above nonaqueous-electrolyte secondary-battery electrode plate according to the present invention. This secondary battery has an electrode plate whose active material layer resists dropping even when the active material layer of the electrode plate packed inside has a high content of the active material. Thus, this secondary battery can have a low rejection rate and can stably offer high-capacity and high-quality performance over a long time.

### BRIEF DESCRIPTION OF THE DRAWINGS

FIG. 1 is a diagram showing an example of a conventional means for cutting an electrode plate;

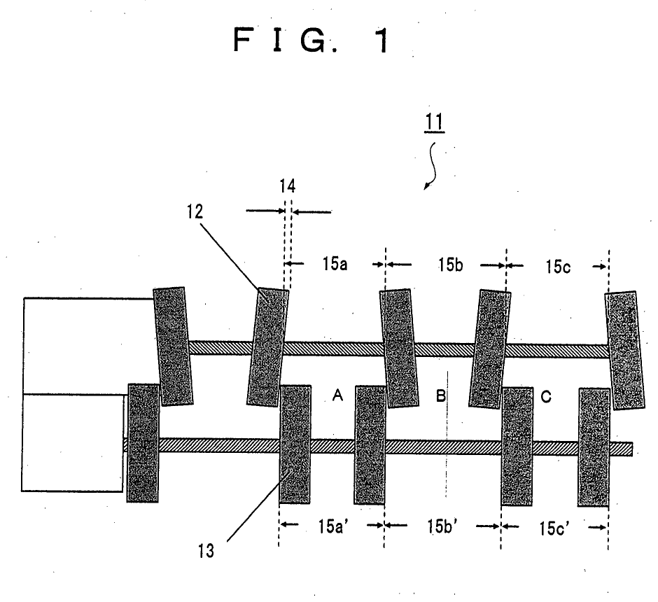

FIG. 2 is an enlarged sectional view showing the state of a conventionally cut electrode plate;

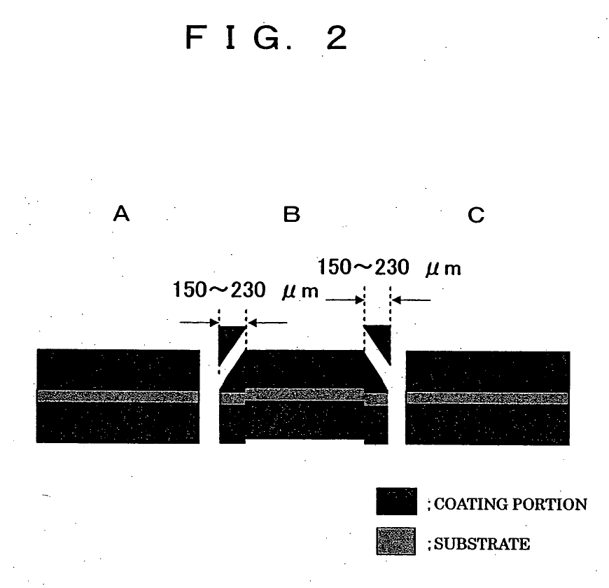

FIG. 3 is a diagram showing an example of a means for cutting a semimanufactured electrode plate according to the present invention;

FIG. 4 is a diagram schematically showing an example of a cutting machine having the means for cutting the semimanufactured electrode plate according to the present invention;

FIGS. 5(a) and 5(b) are enlarged sectional views each showing the state of the semimanufactured electrode plate cut according to the present invention;

FIG. 6 is an enlarged sectional view showing an apparatus for measuring the shear strength in the invention;

FIG. 7 is an enlarged sectional view showing an apparatus for measuring the bending strength in the invention;

FIG. 8 is a graph showing the ranges of the shear strength and the bending strength of the active material layer of the electrode plate, in which the cutting means according to the present invention is suitably used;

FIG. 9 is a graph showing the range of the peel strength of the electrode plate and the range of the bending strength of the active material layer, in which the cutting means according to the present invention is suitably used;

FIG. 10(a) is a schematic diagram showing the shape of an end face when the electrode plate is cut with a conventional gang-blade system as shown in FIG. 1; and

FIG. 10(b) is a schematic diagram showing the shape of an end face when the electrode plate is cut with a cutting means having a certain amount of clearance as shown in FIG. 3 according to the present invention.

Additionally, symbols in the figures respectively represent the following meaning: cutting means (1); 2 upper blade (2); lower blade (3); upper blade shaft (4); 5 lower blade shaft (5); clearance (6); spaces between the blades (7(7a, 7b, 7c, 7a′, 7b′, and 7c′)); supply roll (8); nip roller (9); upper take-up shaft (10a); lower take-up shaft (10b); gang-blade type cutter (11); upper blade of gang-blade (12); lower blade of gang-blade (13); tilt amount (14); space between the blades (15(15a, 15b, 15c, 15a′, 15b′, and 15c′)); semimanufactured electrode plate (20); collector (20a); active material layer (20b).

### DETAILED DESCRIPTION OF THE PREFERRED EMBODIMENTS

The electrode plate for a nonaqueous electrolyte secondary battery of the present invention comprises a collector and an active material layer which is provided on one side or both sides of the collector and contains at least an active material and a binder, wherein the active material layer has an adhesion strength of about 13.5 N/m or less to the collector when provided on both sides of the collector or an adhesion strength of about 6.0 N/m or less to the collector when provided on one side of the collector in terms of JIS-K6854, a shear strength of about 0.10 N/mm² or less in terms of JIS-K7214-1985, and a bending strength of about 15.0 N/mm² or more in terms of JIS-K7171-1994, and the electrode plate is produced by a process comprising the steps of:
providing a semimanufactured electrode plate which comprises a collector and an active material layer provided on the collector, wherein the active material layer has the above adhesion strength, shear strength and bending strength,
providing a cutting means which comprises at least a pair of upper and lower blades each having a disc-like shape or a cylindrical shape and each having a cutting edge at a rim of its end face portion at one or both ends of its axial direction, and two shafts, one of which is for the upper blade supporting the one or more upper blades, and the other of which is for the lower blade supporting the one or more lower blades, wherein the upper and lower blades are opposed to each other with a positional relation that the two shafts are parallel to each other, that the cutting edges of the upper and lower blades are overlapped each other, and that there is a clearance of about 20 μm to about 50 μm between the end face portions of the upper and lower blades overlapping each other, and
allowing the semimanufactured electrode plate to pass between the upper and lower blades of the cutting means so as to cut it.

The method of producing an electrode plate for nonaqueous electrolyte secondary batteries of the present invention comprises the steps of:
providing a semimanufactured electrode plate which comprises a collector and an active material layer provided on the collector,
providing a cutting means which comprises at least a pair of upper and lower blades each having a disc-like shape or a cylindrical shape and each having a cutting edge at a rim of its end face portion at one or both ends of its axial direction, and two shafts, one of which is for the upper blade supporting the one or more upper blades, and the other of which is for the lower blade supporting the one or more lower blades, wherein the upper and lower blades are opposed to each other with a positional relation that the two shafts are parallel to each other, that the cutting edges of the upper and lower blades are overlapped each other, and that there is a clearance of about 20 μm to about 50 μm between the end face portions of the upper and lower blades overlapping each other, and
allowing the semimanufactured electrode plate to pass between the upper and lower blades of the cutting means so as to cut it.

The electrode plate for a nonaqueous electrolyte secondary battery of the present invention is produced by cutting with the above-stated cutting means having an optimized clearance of about 20 μm to about 50 μm between the end face portions of the upper and lower blades overlapping each other. Thus, the active material layer of such an electrode plate is free from dropping of the end face portion in the cutting process, even when the active material layer has low adhesion strength to the collector, low cohesive strength and low shear strength, because of a high content of the active material and a low content of the binder in the active material layer for high capacity purposes and even when the active material layer is compressed under high pressure to have high density and thus high bending strength. In particular, the end face portion of the active material layer is prevented from dropping off, even when the active material layers are provided on both sides of the collector, which would otherwise cause significant dropping or distortion. Thus, the electrode plate for a nonaqueous electrolyte secondary battery of the present invention can have a low rejection rate and can achieve high capacity and high quality.

The method of producing the electrode plate of the present invention includes the step of performing cutting with a cutting means having an optimized clearance of about 20 μm to about 50 μm between the end face portions of the upper and lower blades overlapping each other. Thus, such a method can produce an electrode plate whose active material layer is free from dropping of the end face portion in the cutting process.

The method of producing the electrode plate of the present invention can produce an electrode plate whose active material layer is free from dropping of the end face portion in the cutting process, even when the active material layer of the semimanufactured electrode plate has a shear strength of about 0.10 N/mm² or less in terms of JIS-K7214-1985 and a bending strength of about 15.0 N/mm² or more in terms of JIS-K7171-1994 or even when the active material layer has an adhesion strength of about 13.5 N/m or less to the collector when provided on both sides of the collector in the semimanufactured electrode plate or an adhesion strength of about 6.0 N/m or less to the collector when provided on one side of the collector in the semimanufactured electrode plate in terms of JIS-K6854 and a bending strength of about 15.0 N/mm² or more in terms of JIS-K7171-1994. The method of producing the electrode plate of the invention can produce an electrode plate whose active material layer has less dropping of the end face portion, even when the active material layer has low adhesion strength to the collector, low shear strength and low cohesive strength, because of a high content of the active material and a low content of the binder in the active material layer for high capacity purposes and even when the active material layer is compressed under high pressure to have high density and thus high bending strength. In particular, even when the active material layers are formed on both sides of the collector, which would otherwise cause significant dropping or distortion, an electrode plate whose active material layer has less dropping of the end face portion can be obtained. Thus, the method of the present invention can produce a high-capacity and high-quality electrode plate at a low rejection rate.

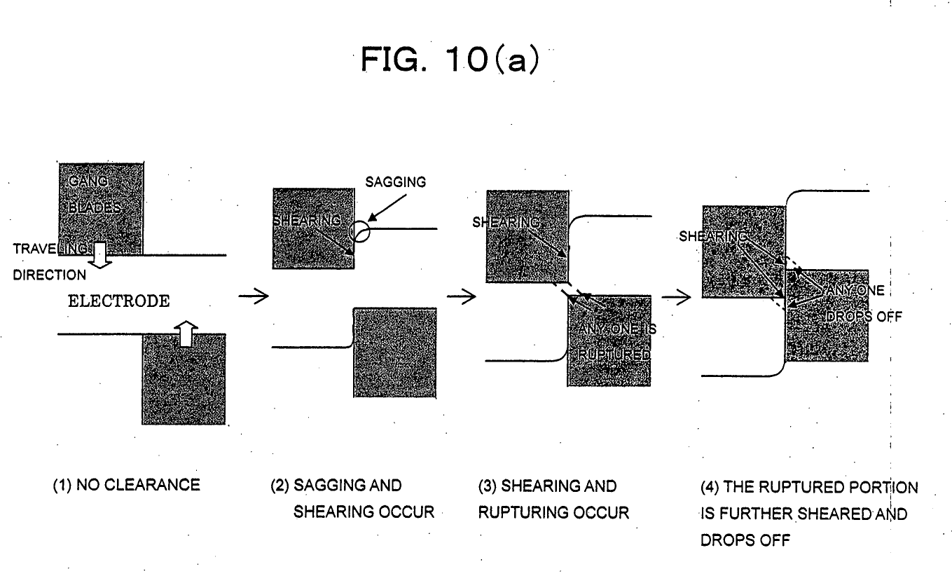

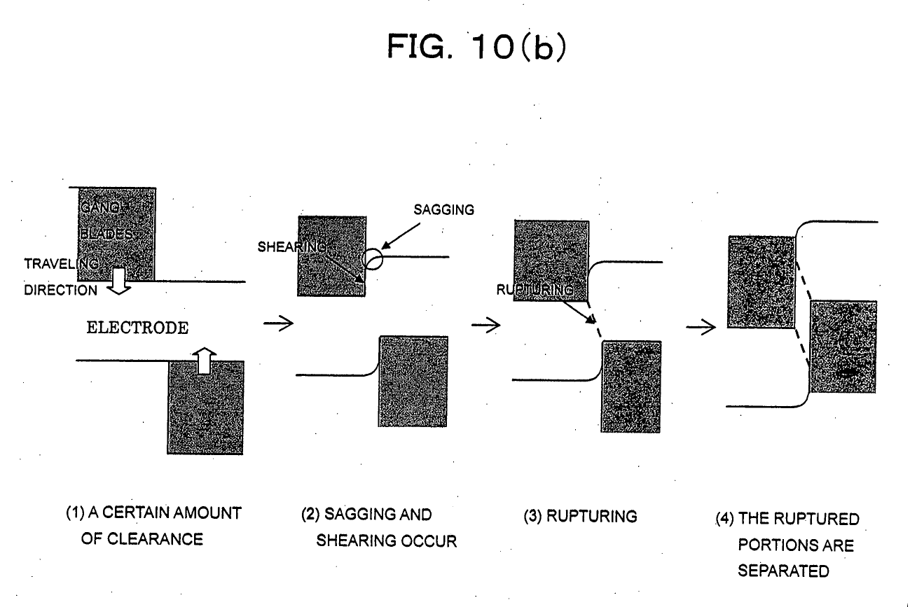

In a conventional gang-blade system with no clearance or very small clearance, the electrode plate is first cut by shearing and then cut by rupturing so that projection portions can be produced at its end. Such projection portions are then entangled with the upper and lower blades so that they can drop off (see FIG. 10(a)). Particularly in an electrode plate with high bending strength and low shear strength (a hard and brittle electrode plate), rupturing proceeds from portions close to both blades in an inclined direction, and cutting occurs at two portions, so that long thin fragments, called beard-like pieces, are produced at a middle portion and that a sharp shear surface cannot be obtained. In contrast, there is an optimized clearance in the present invention, so that projection portions can hardly be caused by rupturing at the final stage of the cutting process and that even if a projection portion is produced, it will not been tangled with the upper and lower blades. Thus, it is believed that cutting is well performed without dropping of the end-face portion of the active material layer (see FIG. 10(b)).

The electrode plate for nonaqueous electrolyte secondary batteries of the present invention may be any of a positive electrode plate and a negative electrode plate.

The semimanufactured electrode plate for nonaqueous electrolyte secondary batteries, which is for use in the present invention, may be produced as follows.

The semimanufactured positive electrode plate may be produced by a process including the step of applying a positive active material layer coating composition, which contains at least a positive active material and a binder, onto one side or both sides of a collector, so as to form a positive active material layer. The semimanufactured negative electrode plate may be produced by a process including the step of applying a negative active material layer coating composition, which contains at least a negative active material and a binder, onto one side or both sides of a collector, so as to form a negative active material layer.

The positive active material may be any conventional positive active material for nonaqueous electrolyte secondary batteries. Examples of such materials include lithium oxides such as LiMn₂O₄ (lithium manganate), LiCoO₂ (lithium cobaltate) and LiNiO₂ (lithium nickelate); and chalcogen compounds such as TiS₂, MnO₂, MoO₃, and V₂O₅. In particular, a lithium secondary battery having a high discharge voltage of about 4 V can be obtained using LiCoO₂ and a carbonaceous material as the positive and negative active materials, respectively.

The positive active material is preferably in the form of a powder having a particle diameter of 1 to 100 μm and an average particle diameter of about 10 μm, in order that it can be uniformly dispersed in a coating layer. One or more of these positive active materials may be used alone or in combination.

The negative active material may be any conventional negative active material for nonaqueous electrolyte secondary batteries. Preferred examples of such materials include carbonaceous materials such as natural graphite, artificial graphite, amorphous carbon, carbon black, and materials wherein a different element is added to any one of these materials. When an organic solvent is used, a lithium-containing metal material such as lithium metal and a lithium alloy is preferably used.

The granular shape of the negative electrode-active material is not particularly limited. Examples thereof include scaly, lump, fibrous, and spherical shapes. The negative active material is preferably in the form of a powder having a particle diameter of 1 to 100 μm and an average particle diameter of about 10 μm, in order that it can be uniformly dispersed in a coating layer. One or more of these negative active materials may be used alone or in combination.

Based on the amount of the components other than the solvent (based on the amount of the solid components), the content of the positive or negative active material in the coating composition is generally from 90 to 98.5% by weight, particularly preferably from 95.2 to 96.6% by weight in terms of achieving high capacity.

The binder may be any conventional binder, for example, including thermoplastic resins. Specific examples of the applicable binder include polyester resins, polyamide resins, polyacrylic ester resins, polycarbonate resins, polyurethane resins, cellulose resins, polyolefin resins, polyvinyl resins, fluorocarbon resins, and polyimide resins. In this case, an acrylate monomer or oligomer having an introduced reactive functional group can be blended into the binder. Other examples of the applicable binder include rubber-based resins, thermosetting resins such as acrylic resins and urethane resins, ionizing radiation-curable resins comprising of an acrylate monomer, an acrylate oligomer or a mixture thereof, and mixtures of the above described various resins.

Based on the amount of the solid components, the content of the binder in the coating composition is generally from 0.5 to 10% by weight, preferably from 2 to 4% by weight or preferably from 1.6 to 2.0% by weight in terms of achieving high capacity.

The positive or negative active material layer coating composition may also contain an electrically conductive agent. For example, a carbonaceous material such as graphite, carbon black or acetylene black is optionally used as the electrically conductive agent. Based on the amount of the solid components, the content of the electrically conductive agent in the coating composition is generally from 1.5 to 2.0% by weight.

The solvent for use in preparation of the positive or negative active material layer coating composition may be an organic solvent such as toluene, methyl ethyl ketone, N-methyl-2-pyrrolidone, or any mixture thereof. The content of the solvent in the coating composition is generally from 30 to 60% by weight, preferably from 45 to 55% by weight, so that the coating liquid can be prepared in the form of a slurry.

The positive or negative active material layer coating composition may be prepared in the form of a slurry by adding an appropriately selected positive or negative active material, a binder and any other component to an appropriate solvent, and mixing and dispersing them in a dispersing machine such as a homogenizer, a ball mill, a sand mill, a roll mill, and a planetary mixer.

The positive or negative active material layer coating composition prepared as described above is applied to one side or both sides of a collector, which is a base material, and dried to form a positive or negative active material layer. In general, an aluminum foil is preferably used as a collector for the positive electrode plate. A copper foil such as an electrolytic copper foil and a rolled copper foil is preferably used as a collector for the negative electrode plate. The collector generally has a thickness of about 5 to about 50 μm.

Any coating method may be used to apply the positive or negative active material layer coating composition. A coating method capable of forming a thick coating layer is suitable, such as slide die coating, comma direct coating, and comma reverse coating. When a relatively thin active material layer is required, gravure coating, gravure reverse coating or the like may be used in the application process. The active material layer may be formed by repeating application and drying more than once.

In the drying process, the heat source may be hot air, infrared radiation, microwave, high-frequency wave, or any combination thereof. In the drying process, heat may be released from a heated metal roller or sheet for supporting or pressing the collector and used for drying. By radiating electron beams or radioactive rays after the drying, the binders are caused to crosslink-react so that the active material layer can be obtained. Application and drying may be repeated more than once.

In addition, the resulting positive or negative active material layer may be pressed so that the active material layer can have a higher density or improved homogeneity or exhibit increased adhesion to the collector.

For example, the press working is performed using a metal roll, an elastic roll, a heating roll, a sheet pressing machine, or the like. In the present invention, the press-working may be performed at room temperature or raised temperature as far as the press temperature is lower than the temperature for drying the coating layer of the active material layer. The press-working is usually performed at room temperature (typically ranging from 15 to 35° C.).

Roll press is preferred, because it allows continuous press working of a long sheet-shaped negative electrode plate. The roll press may be static press or constant pressure press. The line speed of the press is generally from 5 to 50 m/min. When the pressure of the roll-press is controlled by line pressure, the line pressure, which is adjusted dependently on the diameter of the pressing roll, is usually set to 0.5 kgf/cm to 2 tf/cm.

When sheet pressing is performed, the pressure is generally controlled in the range from 4903 to 73550 N/cm² (500 to 7500 kgf/cm²), preferably in the range from 29420 to 49033 N/cm² (3000 to 5000 kgf/cm²). If the pressing pressure is too low, the active material layer can be less homogeneous. If the pressing pressure is too high, the electrode plate itself including the collector can be broken. The active material layer may be pressed once so as to have the desired thickness or may be pressed several times for the purpose of improving the homogeneity.

The coating amount of the positive or negative active material layer is generally from 20 to 350 g/m². The thickness of the coating is generally set in the range from 10 to 200 μm, preferably in the range from 50 to 170 μm, after the drying and pressing processes. The density of the negative active material layer may be about 1.0 g/cc after the coating process but can be increased to at least 1.5 g/cc (generally about 1.5 to 1.75 g/cc) after the pressing process. When the press working is performed without any trouble so as to improve the volume energy density, a high capacity battery can be produced.

The resulting active material layer of the electrode plate contains at least the positive or negative active material and the binder and optionally the electrically conductive agent and/or any other component. After the drying process, the content of each component in the active material layer may be the same as the above content based on the amount of the solid components of the active material layer coating composition.

In the semimanufactured electrode plate, the content of the binder in the active material layer is preferably as low as possible in terms of achieving high capacity. If the binder content is low, however, the active material layer can be brittle and thus can have low cohesive strength, low adhesion strength to the collector and low shear strength, so that dropping or cracking can easily occur at the end portion of the active material layer in the cutting process. In addition, for the purpose of achieving high capacity, the active material layer is preferably compressed under high pressure so as to have high density in the semimanufactured electrode plate. If the active material layer increases in density, however, it can be hard and thus can have high bending strength, so that the end portion of the active material layer can easily drop off in the cutting process. In the present invention, against these problems, cutting is performed with the cutting means having an optimized clearance of about 20 μm to about 50 μm between the end face portions of the upper and lower blades overlapping each other, so that dropping or cracking can hardly occur at the end portion of the active material layer during the cutting process, even when the active material layer is very hard and brittle and thus has high bending strength and low shear or adhesion strength.

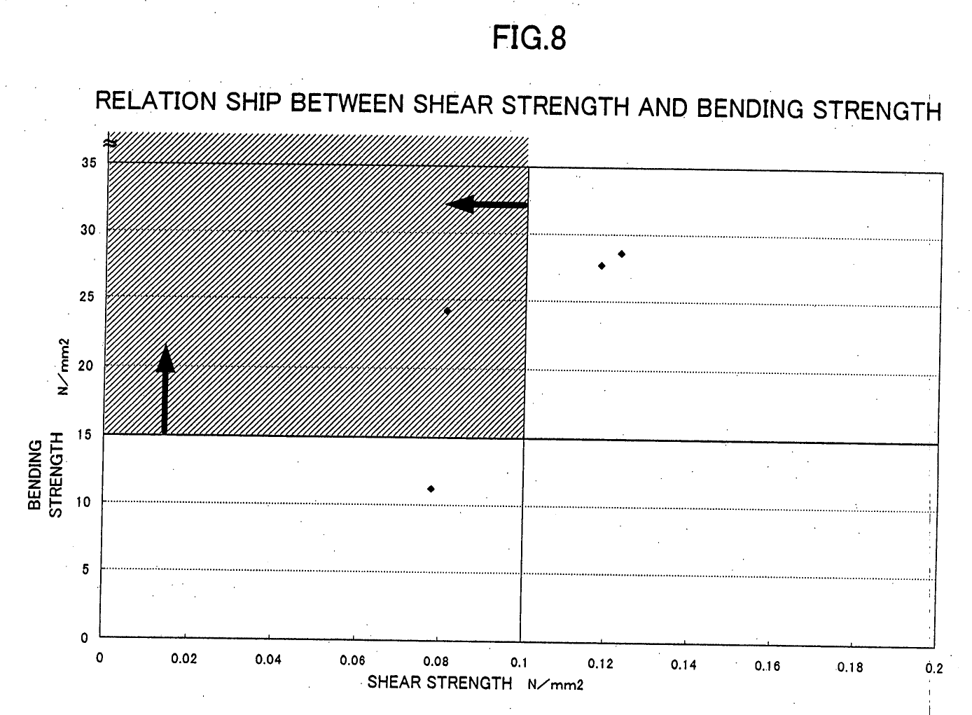

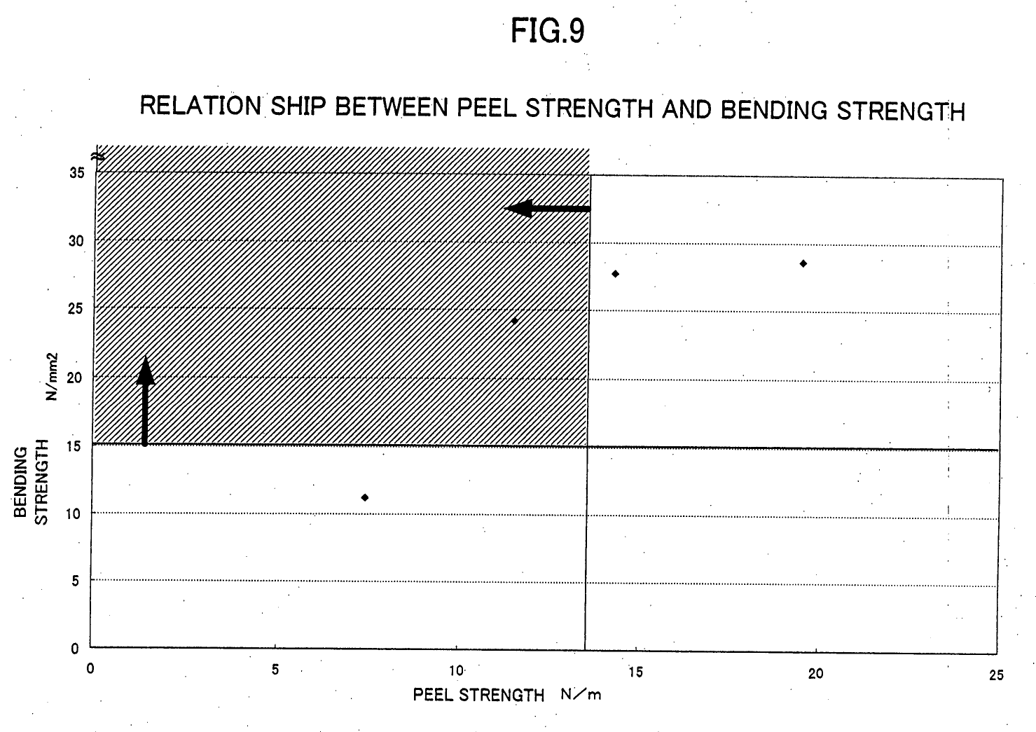

For example, even when the active material layer of the semimanufactured electrode plate has a shear strength of about 0.10N/mm² or less in terms of JIS-K7214-1985 and a bending strength of about 15.0 N/mm² or more in terms of JIS-K7171-1994 (see FIG. 8), the end portion of the active material layer can be prevented from dropping off or cracking in the cutting process using the cutting means according to the present invention. Even when the active material layer of the semimanufactured electrode plate has an adhesion strength of about 13.5 N/m or less to the collector when provided on both sides of the collector in the electrode plate or an adhesion strength of about 6.0 N/m or less to the collector when provided on one side of the collector in terms of JIS-K6854 and a bending strength of about 15.0 N/mm or more in terms of JIS-K7171-1994 (see FIG. 9), the end portion of the active material layer can also be prevented from dropping off or cracking in the cutting process using the cutting means according to the present invention. Even when the active material layer of the semimanufactured electrode plate has: an adhesion strength of about 13.5 N/m or less to the collector when provided on both sides of the collector or an adhesion strength about of 6.0 N/m or less to the collector when provided on one side of the collector in terms of JIS-K6854; a shear strength of about 0.10 N/mm or less in terms of JIS-K7214-1985; and a bending strength of about 15.0 N/mm² or more in terms of JIS-K7171-1994, the end portion of the active material layer can also be prevented from dropping off or cracking in the cutting process using the cutting means according to the present invention.

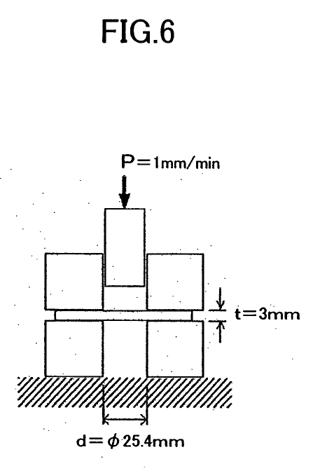

The shear strength of the active material layer can indicate the “firmness” or “brittleness” of the active material layer. The term “firm” means a state where matters are tightly associated and not easily separated. The term “brittle” means a state where the load bearing ability is low or a state where collapse or fracture can easily occur. In the present invention, the shear strength of the active material layer can be determined using the test method and the shape of the test piece according to JIS-K7214-1985 or ASTM D732. For example, the shear strength may be evaluated using a universal testing machine (such as RTC-1250A manufactured by A & D Co., Ltd.) with a cross head moving at a constant speed as shown in FIG. 6. Shear loads are applied by shifting the cross head at a rate of 1 mm/minute until the test piece is ruptured. The resulting maximum value P of the shear loads is divided by the sectional area of the sheared portion ((d/2)²π), and the resulting quotient is used as a shear strength τ for evaluation. The shear strength of the active material layer can be obtained by subtracting the shear strength of the collector itself from the shear strength of the semimanufactured electrode plate.

The adhesion strength of the active material layer to the collector can also indicate the “firmness” or “brittleness” of the active material layer. In the present invention, the adhesion strength of the active material layer to the collector may be determined by the test method according to JIS-K6854 (revision on Jan. 1, 1994), which is a 90° peel strength test. When the active material layer is provided on one side, the adhesion strength of the one-side coating to the substrate is determined by a process including the steps of: fixing the coating layer side of a test piece onto a stage with a double-faced tape; and pulling an end of the test piece in a direction perpendicular to the coating layer surface so as to peel an about 50 mm portion continuously at a rate of about 50 mm per minute. In this process, loads are measured, and the minimum value of the loads is used as a peel strength for the evaluation of the adhesion strength of the coating film to the substrate. When the active material layer is provided on both sides, one of the two coatings may be wiped away, and then the adhesion strength of the other coating film to the substrate may be measured, a portion necessary for the test is wiped away with a solvent from one side, and then the adhesion strength of the other-side coating film to the substrate is determined in the same manner as in the above case that the coating is provided on only one side. In addition, when the active material layer is provided on both sides, the adhesion strength of the both-sides coating to the substrate may be determined by a process including the steps of: fixing one of both coatings onto a stage with a double-faced tape; and determining the adhesion strength both-sides coating film to the substrate in the same manner as in the above case that the coating is provided on only one side.

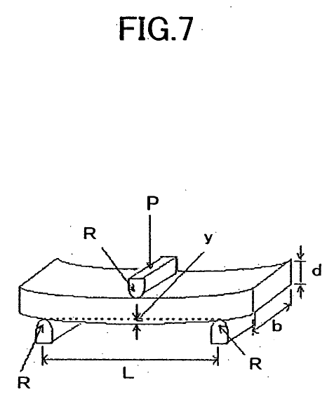

The bending strength of the active material layer can indicate the degree of “hardness” or “softness” of the active material layer. The term “hard” means that the material does not easily change its shape or state when a force is applied to it. The term “soft” means that the material is flexible. In the present invention, the bending strength of the active material layer may be determined using the test method and the shape of the test piece according to JIS-K7171-1994, ISO 178 or ASTMD790. For example, the bending strength may be evaluated using a universal testing machine (such as RTC-1250A manufactured by A & D Co., Ltd.) capable of pressing at a constant speed as shown in FIG. 7. Loads are applied to the center of the test piece by shifting a pressing wedge at a rate of 30 mm/minute until the test piece is ruptured. The resulting maximum value of the bending stresses σ (wherein σ=3/2×PL/(bd²)) is used as a bending strength for evaluation. In general, the bending strength of the collector may be assumed to be 0. Thus, the measured bending strength of the electrode plate or the semimanufactured electrode plate may be assumed to be the bending strength of the active material layer.

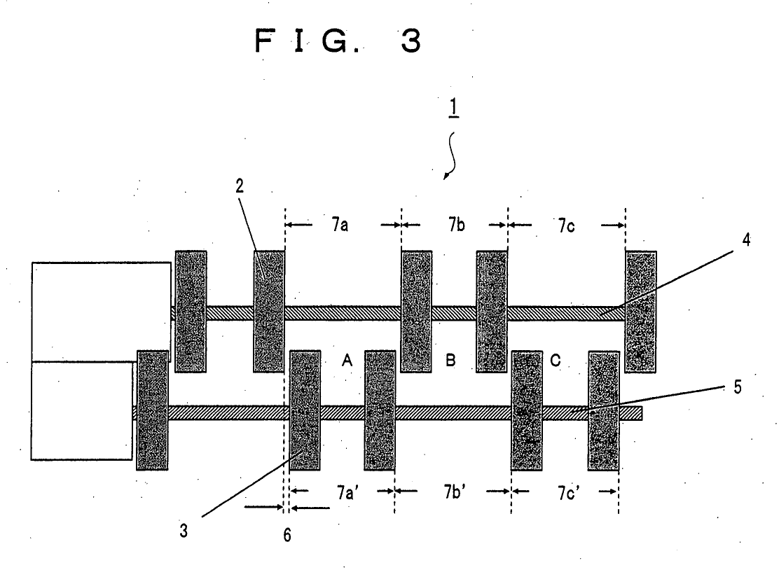

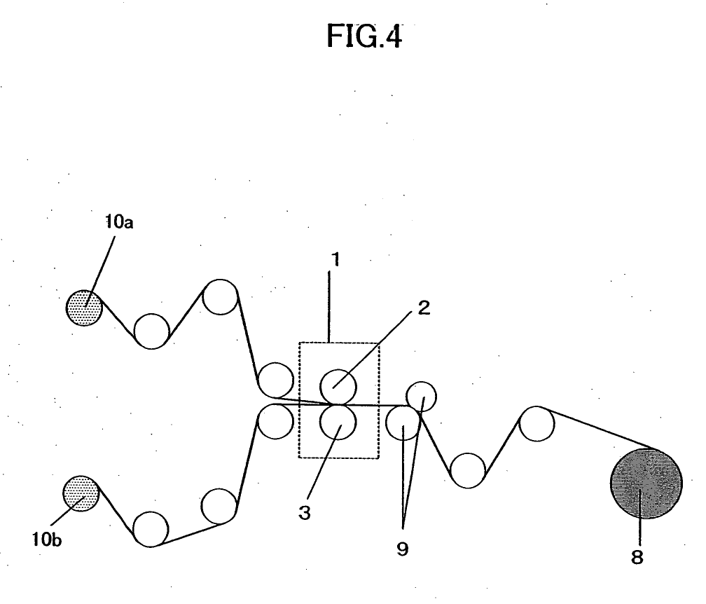

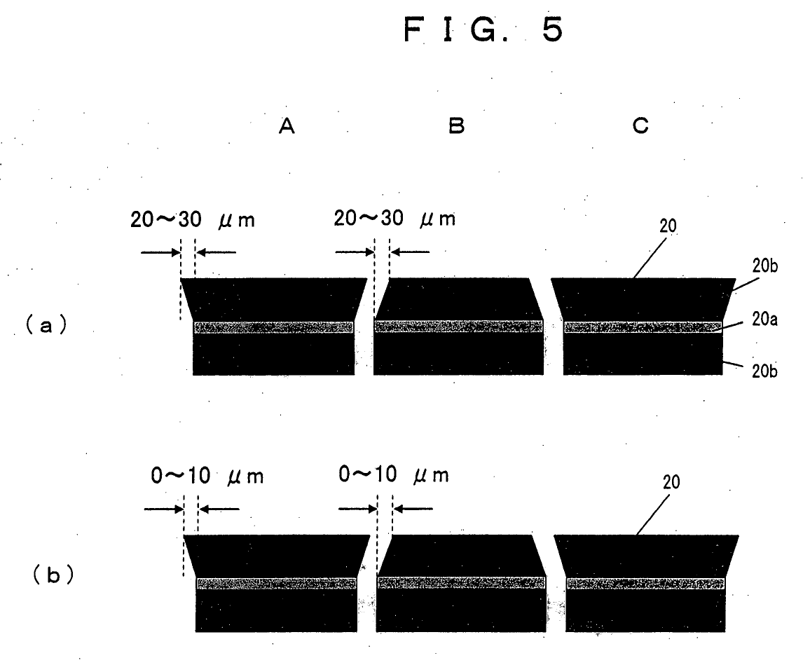

FIG. 3 is a diagram showing an example of the means for cutting the semimanufactured electrode plate according to the present invention; FIG. 4 is a diagram schematically showing an example of a cutting machine having the means for cutting the semimanufactured electrode plate according to the present invention; and FIG. 5 is an enlarged sectional view showing the state of the semimanufactured electrode plate cut according to the present invention.

A cutting means 1 for cutting the semimanufactured electrode plate according to the present invention basically comprises one or more upper blades 2 supported by an upper blade shaft 4 and one or more lower blades 3 supported by a lower blade shaft 5 and for example, is placed in the cutting machine as shown in FIG. 4. In the cutting machine, for example, the semimanufactured electrode plate is supplied from a supply roll 8, allowed to pass through nip rollers 9, and then cut with the upper blade 2 and the lower blade 3 of the cutting means 1. Each piece of the cut electrode plate is wound around upper and lower take-up shafts 10a and 10b alternately or in a staggered manner.

In the cutting means 1, the upper blade 2 and the lower blade 3 are each in the shape of a disc or a cylinder and each have an arc-shaped cutting edge, which is provided at a rim of its end face portion at one or both ends of its axial direction and has an endless rotational orbit. The supported upper and lower blades 2 and 3 are each not inclined with respect to the shaft. The end face portion defined by the cutting edge forms a plane perpendicular to the center axis of the blade. In the cutting machine, the upper blade 2 and the lower blade 3 are placed in the so-called gang-type arrangement. Specifically, the upper blade 2 and the lower blade 3 are arranged in the cutter so that the upper blade shaft 4 and the lower blade shaft 5 are parallel to each other and that the edges of the upper blade 2 and the lower blade 3 overlap each other, in other words, the projection planes of the upper blade 2 and the lower blade 3 as viewed from the axial direction overlap each other, while they have a small clearance in the axial direction and are opposed to each other in a slanting direction.

According to the present invention, the clearance 6 between the end face portions of the upper blade 2 and the lower blade 3 overlapping each other is controlled in the range from about 20 μm to about 50 μm, more preferably in the range from about 30 μm to about 40 μm, particularly preferably at about 30 μm. For example, when the clearance 6 is set at 50 μm, the spaces 7a, 7b, 7c, 7a′, 7b′, and 7c′ between the blades may be set at 41.00 mm, 40.90 mm, 41.00 mm, 40.90 mm, 41.00 mm, and 40.90 mm, respectively. When the clearance 6 is set at 30 μm, the spaces 7a, 7b, 7c, 7a′, 7b′, and 7c′ between the blades may be set at 41.00 mm, 40.94 mm, 41.00 mm, 40.94 mm, 41.00 mm, and 40.94 mm, respectively.

As shown in the example of FIG. 3, it is preferred that the supported upper and lower blades should not be inclined with respect to the shafts and that the end face portion defined by the cutting edge should form a plane perpendicular to the center axis of the blade. As long as the clearance between the end face portions of the upper and lower blades overlapping each other satisfies the above range, however, the upper and lower blades may be inclined with respect to the shafts, respectively, and the end face portion defined by the cutting edge may not form a plane perpendicular to the center axis of the blade.

Since the cutting means 1 for use in the present invention is configured as described above, in the process of cutting a semimanufactured electrode plate 20 comprising a collector 20a and an active material layer 20b provided on one side or both sides of the collector 20a with the cutting means 1, the semimanufactured electrode plate 20 is allowed to pass between the upper blade 2 and the lower blade 3. Thus, the semimanufactured electrode plate 20 is cut into the shape as shown in FIG. 5(a) or 5(b) with the upper and lower blades 2 and 3. FIG. 5(a) shows the shape when the clearance 6 is set at 50 μm; FIG. 5(b) shows the shape when the clearance 6 is set at 30 μm.

According to the present invention, cutting is performed with the cutting means having an optimized clearance of about 20 μm to about 50 μm between the end face portions of the upper and lower blades overlapping each other. Thus, the end face of the active layer can be prevented from dropping off, even when the active material layer has low adhesion strength to the collector, low cohesive strength and low shear strength, because of a low content of the binder in the active material layer, and even when the active material layer is compressed and thus has high bending strength.

It is has been believed that when an optimal amount of clearance is provided, projection portions can hardly be caused by rupturing at the final stage of the cutting process, and even if a projection portion is produced, it will not be entangled with the upper and lower blades, so that cutting is well performed without dropping of the end face portion of the active material layer. The cross-sectional shape of the electrode plate cut according to the present invention may have obliquely cut portions which are not completely perpendicular to the electrode plate because of the effects of shear stress and rupture stress. As shown in FIGS. 5(a) and 5(b), however, the deviation of the obliquely cut portion from the horizontal direction is as small as about 20 μm to about 30 μm when the clearance 6 is set at about 50 μm and as small as about 0 μm to about 10 μm when the clearance 6 is set at about 30 μm. Therefore, even when for the purpose of achieving high capacity, the active material layer of the semimanufactured electrode plate has low adhesion strength and is brittle and hard, namely has low shear strength and high bending strength, dropping, which is known to cause self-discharge (soft short, OCV failure), can be prevented in the cutting process.

According to the above description, the electrode plate for nonaqueous electrolyte secondary batteries of the present invention can be obtained, and nonaqueous electrolyte secondary batteries can be produced using the present electrode plate.

When an secondary battery is produced using the electrode plate according the present invention, it is preferred that aging such as heat treatment or reduced pressure treatment for the purpose of removing water from the active material layer should previously be performed using a vacuum oven or the like before the process of constructing the battery is started.

The positive and negative electrode plates produced by the above method are wound into a swirl form with a separator such as a porous polyethylene film interposed therebetween and inserted into a packing container. After the insertion, a lead is connected between a terminal connection part of the positive electrode plate (an exposed surface of the collector) and a positive terminal provided on the upper surface of the packing container, while another lead is connected between a terminal connection part of the negative electrode plate (another exposed surface of the collector) and a negative terminal provided on the bottom surface of the packing container. The packing container is then filled with a liquid nonaqueous electrolyte and sealed so that a nonaqueous electrolyte secondary battery comprising the electrode plate according to the present invention is completed.

When a lithium secondary battery is produced, a solution of a lithium salt (which is a solute) in an organic solvent is used as the liquid nonaqueous electrolyte. The lithium salt may be an inorganic lithium salt such as LiClO₄, LiBF₄, LiPF₆, LiAsF₆, LiCl, and LiBr; or an organic lithium salt such as LiB(C₆H₅)₄, LiN(SO₂CF₃)₂, LiC(SO₂CF₃)₃, LiOSO₂CF₃LiOSO₂C₂F₅, LiOSO₂C₃F₇, LiOSO₂C₄F₉, LiOSO₂C₅F₁₁, LiOSO₂C₆F₁₃, and LiOSO₂C₇F₁₅.

Examples of the organic solvent for use in dissolving the lithium salt include cyclic esters, chain esters, cyclic ethers, and chain ethers. Specific examples of the cyclic esters include ethylene carbonate, propylene carbonate, butylene carbonate, γ-butyrolactone, vinylene carbonate, 2-methyl-γ-butyrolactone, acetyl-γ-butyrolactone, and γ-valerolactone.

Examples of the chain esters include dimethyl carbonate, diethyl carbonate, dibutyl carbonate, dipropyl carbonate, methyl ethyl carbonate, methyl butyl carbonate, methyl propyl carbonate, ethyl butyl carbonate, ethyl propyl carbonate, butyl propyl carbonate, alkyl propionate, dialkyl malonate, and alkyl acetate.

Examples of the cyclic ethers include tetrahydrofuran, alkyltetrahydrofuran, dialkyltetrahydrofuran, alkoxytetrahydrofuran, dialkoxytetrahydrofuran, 1,3-dioxolane, alkyl-1,3-dioxolane, and 1,4-dioxolane.

Examples of the chain ethers include 1,2-dimethoxyethane, 1,2-diethoxyethane, diethyl ether, ethylene glycol dialkyl ether, diethylene glycol dialkyl ether, triethylene glycol dialkyl ether, and tetraethylene glycol dialkyl ether.

As described above, the electrode plate for a nonaqueous electrolyte secondary battery of the present invention is produced by cutting with the above-stated cutting means having an optimized clearance of about 20 μm to about 50 μm between the end face portions of the upper and lower blades overlapping each other. Thus, the active material layer of such an electrode plate is free from dropping of the end face portion in the cutting process, even when the active material layer has low adhesion strength to the collector, low cohesive strength and low shear strength, because of a high content of the active material and a low content of the binder in the active material layer for high capacity purposes and even when the active material layer is compressed under high pressure to have high density and thus high bending strength. In particular, the end face portion of the active material layer is prevented from dropping off, even when the active material layers are provided on both sides of the collector, which would otherwise cause significant dropping or distortion. Thus, the electrode plate for a nonaqueous electrolyte secondary battery of the present invention can have a low rejection rate and can achieve high capacity and high quality.

In addition, the method of producing the electrode plate of the present invention includes the step of performing cutting with a cutting means having an optimized clearance of about 20 μm to about 50 μm between the end face portions of the upper and lower blades overlapping each other. Thus, the method of the present invention can produce an electrode plate whose active material layer is free from dropping of the end face portion in the cutting process, even when for the purpose of producing a high capacity electrode plate, the content of the active material in the active material layer is increased, and the active material layer is compressed under high pressure to have high density and thus to have low adhesion strength, low shear strength and high bending strength. In particular, even when the active material layers are formed on both sides of the collector, which would otherwise cause significant dropping or distortion, an electrode plate whose active material layer has less dropping of the end face portion can be obtained. Thus, the method of the present invention can improve the yield.

The secondary battery according to the present invention has an electrode plate whose active material layer resists dropping even when the active material layer of the electrode plate packed inside has a high content of the active material. Thus, this secondary battery can have a low rejection rate and can stably offer high-capacity and high-quality performance over a long time.

### EXAMPLES

### Example 1

An active material layer coating composition was prepared by mixing 100 parts by weight of LiCoO₂ powder as positive active material, 1.5 parts by weight of acetylene black as electrically conductive agent for positive electrode, 2.0 parts by weight of polyvinylidene fluoride as binder for positive electrode, and N-methyl-pyrrolidone as solvent in a planetary mixer. Using a die coater, the active material layer coating composition was intermittently applied to both sides of a 15 μm thick aluminum foil. The amount of the coating per one side was about 219.19 g/m². When coating was performed on only one side, the coating length was 0.762 m. When coating was performed on both sides, the coating length was 0.762 m for the first side and 0.692 m for the second side. The resulting semimanufactured electrode plate having the active material layer was rolled using a roller press. The rolled semimanufactured electrode plate was cut into 0.042 m wide pieces using the cutting means according to the invention, which had a clearance of 30 μm between the end face portions of the blades.

### Comparative Examples 1 to 4

According to the composition as shown in Table 1, each active material layer coating composition was prepared, and coating and rolling were performed in the same manner as Example 1. Cutting was performed in a conventional gang-blade system with no clearance.

<Evaluations>

The electrode plate obtained in each of the example and the comparative examples was measured for the adhesion strength of the coating film to the substrate by the 90° peel strength test with respect to: both-sides coating; one-side coating of the both-sides coating after wiping away of the other side (both sides coating with one side wiped away); and a coating portion provided on only one side (one-side coating). Also measured were the shear strength and bending strength of the both-sides coating. The presence or absence of the dropping in the cutting process was also checked. The battery capacity was also calculated. In comparison with the conventional electrode of Comparative Example 1 having a high adhesion strength, the rate of rise in the battery capacity is also shown in Table 1.

(Evaluation of Adhesion Strength (90° Peel Strength Test))

The test was performed according to JIS-K6854. The adhesion strength of the one-side coating to the substrate was determined by a process including the steps of: fixing the coating layer side of a test piece onto a stage with a double-faced tape; and pulling an end of the test piece in a direction perpendicular to the coating layer surface so as to peel an about 50 mm portion continuously at a rate of about 50 mm per minute. In this process, loads were measured, and the minimum value of the loads was used as a peel strength for the evaluation of the adhesion strength of the coating film to the substrate. Adhesion strength test was also performed on the one-side coating of the both-sides coating after wiping away of the other side, wherein a portion necessary for the test was wiped away with a solvent from the other side, and then the adhesion strength of the one-side coating film to the substrate was measured in the same manner as when the coating was provided on only one side. In addition, the adhesion strength of the both-sides coating film to the substrate was determined by a process including the steps of: fixing one of both coatings onto a stage with a double-faced tape; and determining the adhesion strength of the both-sides coating film to the substrate in the same manner as when the coating was provided on only one side.

(Evaluation of Shear Strength of Active Material Layer)

The shear strength was measured using the test method and the shape of the test piece according to JIS-K7214-1985 or ASTM D732. The shear strength was determined using a universal testing machine (RTC-1250A manufactured by A & D Co., Ltd.) with a cross head moving at a constant speed as shown in FIG. 6. Shear loads were applied by shifting the cross head at a rate of 1 mm/minute until the test piece was ruptured. The resulting maximum value of the shear loads was divided by the sectional area of the sheared portion, and the resulting quotient was used as a shear strength for evaluation. The shear strength of the active material layer was obtained by subtracting the measured shear strength of the collector itself from the measured shear strength of the semimanufactured electrode plate.

(Evaluation of Bending Strength of Active Material Layer)

The bending strength was measured using the test method and the shape of the test piece according to JIS-K7171-1994, ISO 178 or ASTM D790. The test piece used had a long side of 75 mm, a short side (b) of 40 mm, and any thickness (d). The bending strength was determined using a universal testing machine (RTC-1250A manufactured by A & D Co., Ltd.) capable of pressing at a constant speed as shown in FIG. 7. The pressing wedge used had a tip diameter (R) of 3.2 mm. The supporting stage used had a distance (L) of 20 mm between the supporting points and a tip diameter (R) of 3.2 mm. Loads were applied to the center of the test piece by shifting the pressing wedge at a rate of 30 mm/minute until the test piece was ruptured. The resulting maximum value of the bending stresses σ (wherein σ=3/2×PL/(bd²)) was used as a bending strength for evaluation. The bending strength of the collector was 0, and thus, the measured bending strength of the electrode plate or the semimanufactured electrode plate was assumed to be the bending strength of the active material layer.

(Battery Capacity)

The battery capacity is calculable from the theoretical capacity (140 mAh/g) of the LiCoO₂ powder used as the positive active material, the amount of the one-side coating, the coating area, and the content of the active material in the active material layer coating composition. In the case of Example 1, for example, the battery capacity is calculated as follows: 140(mAh, theoretical capacity)×219.19(g/m², the amount of one-side coating)×(0.629+0.762)(m, coating length)×0.042(cutting width)×100/103.5(the content of the active material in the active material layer coating composition). The rate of rise in capacity was obtained relative to the capacity of Comparative Example 1.

TABLE 1

| | | Example | Comparative Example | | | |
|---|---|---|---|---|---|---|
| | | 1 | 1 | 2 | 3 | 4 |
| Positive Active | Parts by Weight | 100 | 100 | 100 | 100 | 100 |
| Material | | | | | | |
| Conductive Agent | | 1.5 | 3 | 2 | 2 | 1.5 |
| Binder | | 2 | 4 | 3 | 1.6 | 2 |
| Adhesion | Both-Sides Coating | 11.53 | 19.47 | 14.31 | 7.37 | 11.53 |
| (Peel Strength) | One-Side Coating of the | 4.03 | 12.97 | 6.64 | 4.04 | 4.03 |
| (N/m) | Both-Sides Coating | | | | | |
| | (One Side Wiped Away) | | | | | |
| | One-Side Coating | 4.27 | 11.95 | 6.17 | 4.20 | 4.27 |
| Shear Strength | Both-Sides Coating | 0.081 | 0.123 | 0.118 | 0.078 | 0.081 |
| (N/mm²) | | | | | | |
| Bending Strength | Both-Sides Coating | 24.2 | 28.6 | 27.7 | 11.2 | 24.2 |
| (N/mm²) | | | | | | |
| Amount of Clearance (μm) | | 30 | Zero | Zero | Zero | Zero |
| Dropping | | Absent | Absent | Absent | Absent | Present |
| Battery Capacity | mAh | 1811 | 1751 | 1785 | 1809 | 1811 |
| Rate of Rise in | % | 3.38 | — | 1.90 | 3.28 | 3.38 |
| Capacity | | | | | | |

The battery capacity of Example 1 is 3.38% higher than that of Comparative Example 1 having a relatively high content of the binder in the active material layer. In Example 1, the electrode achieved a high capacity, and cutting was performed with the cutting means according to the invention so that dropping did not occur in the process of cutting the electrode plate, even with a low adhesion strength, a low shear strength and a high bending strength of the active material layer. In contrast, dropping of the active material layer from the end face of the electrode was observed in Comparative Example 4, wherein the electrode plate produced with the same active material layer coating composition as that of Example 1 was cut using the conventional gang-blade system.

1. An electrode plate for a nonaqueous electrolyte secondary battery, comprising a collector and an active material layer which is provided on one side or both sides of the collector and contains at least an active material and a binder, wherein the active material layer has an adhesion strength of about 13.5 N/m or less to the collector when provided on both sides of the collector or an adhesion strength of about 6.0 N/m or less to the collector when provided on one side of the collector in terms of JIS-K6854, a shear strength of about 0.10 N/mm or less in terms of JIS-K7214-1985, and a bending strength of about 15.0 N/mm² or more in terms of JIS-K7171-1994, and the electrode plate is produced by a process comprising the steps of:
providing a semimanufactured electrode plate which comprises a collector and an active material layer provided on the collector, wherein the active material layer has the above adhesion strength, shear strength and bending strength,
providing a cutting means which comprises at least a pair of upper and lower blades each having a disc-like shape or a cylindrical shape and each having a cutting edge at a rim of its end face portion at one or both ends of its axial direction, and two shafts, one of which is for the upper blade supporting the one or more upper blades, and the other of which is for the lower blade supporting the one or more lower blades, wherein the upper and lower blades are opposed to each other with a positional relation that the two shafts are parallel to each other, that the cutting edges of the upper and lower blades are overlapped each other, and that there is a clearance of about 20 μm to about 50 μm between the end face portions of the upper and lower blades overlapping each other, and
allowing the semimanufactured electrode plate to pass between the upper and lower blades of the cutting means so as to cut it.

2. The electrode plate according to claim 1, wherein the active material layer is provided on both sides of the collector.

3. A method of producing an electrode plate for a nonaqueous electrolyte secondary battery, comprising the steps of:
providing a semimanufactured electrode plate which comprises a collector and an active material layer provided on the collector,
providing a cutting means which comprises at least a pair of upper and lower blades each having a disc-like shape or a cylindrical shape and each having a cutting edge at a rim of its end face portion at one or both ends of its axial direction, and two shafts, one of which is for the upper blade supporting the one or more upper blades, and the other of which is for the lower blade supporting the one or more lower blades, wherein the upper and lower blades are opposed to each other with a positional relation that the two shafts are parallel to each other, that the cutting edges of the upper and lower blades are overlapped each other, and that there is a clearance of about 20 μm to about 50 μm between the end face portions of the upper and lower blades overlapping each other, and
allowing the semimanufactured electrode plate to pass between the upper and lower blades of the cutting means so as to cut it.

4. The method according to claim 3, further comprising a step of subjecting the active material layer of the semimanufactured electrode plate to a pressing work.

5. The method according to claim 3, wherein the active material layer of the semimanufactured electrode plate has a shear strength of about 0.10 N/mm² or less in terms of JIS-K7214-1985 and a bending strength of about 15.0 N/mm² or more in terms of JIS-K7171-1994.

6. The method according to claim 3, wherein the active material layer of the semimanufactured electrode plate has an adhesion strength of about 13.5 N/m or less to the collector when provided on both sides of the collector or an adhesion strength of about 6.0 N/m or less to the collector when provided on one side of the collector in terms of JIS-K6854 and a bending strength of about 15.0 N/mm² or more in terms of JIS-K7171-1994.

7. The method according to claim 3, wherein the active material layer is provided on both sides of the collector in the semimanufactured electrode plate.

8. A nonaqueous electrolyte secondary battery, comprising the electrode plate according to claim 1.
